(19) United States
(12) Patent Application Publication
(10) Pub. No.: US 2026/0099188 A1
(43) Pub. Date: Apr. 9, 2026

(54) SYSTEM AND METHOD FOR HANDLING SLEEP STATE FAILURE IN A PROCESSING SYSTEM

(71) Applicant: QUALCOMM Incorporated, San Diego, CA (US)

(72) Inventors: Shriharsha CHEBBI, Hyderabad (IN); Nirav Narendra DESAI, Hyderabad (IN); Lakshmi Narayana PANUKU, Hyderabad (IN)

(21) Appl. No.: 18/910,196

(22) Filed: Oct. 9, 2024

(51) Int. Cl. G06F 1/3287

(52) U.S. Cl. CPC G06F 1/3287

(57) ABSTRACT

Implementations of systems and methods for coordinating the sleep mode of a vehicle processor and coprocessor. The systems and methods may include determining whether each of a plurality of subsystems is in an operational state that permits entering the sleep state, transmitting, from the processor to the coprocessor, a trigger message, and switching the plurality of subsystems into the sleep state. The systems and methods may identify by the coprocessor whether each of the plurality of subsystems has switched to the sleep state, start a first timer with a predetermined time period, and switch the processor and coprocessor to the sleep state within the predetermined time period in response to identifying whether each of the plurality of subsystems has switched to the sleep state.

### BACKGROUND

Vehicular electronics have increasingly become more complicated with various subsystems, sensors, and controls. For example, vehicles may now have integrated infotainment systems, driver assistance control systems, and engine controls and sensors. These systems may communicate and may have interdependencies. These interdependencies and independent systems can result in process failures when the system is shut off when the vehicle ignition is turned off.

### SUMMARY

Various aspects include systems and methods for coordinating a sleep state for a processor and a coprocessor including transmitting, from the processor to the coprocessor, a trigger message when a plurality of subsystems are in operational states that permit entering the sleep state. The systems and methods may include starting, by the coprocessor a first timer with a predetermined time period, in response to the plurality of subsystems being switched to the sleep state, and switching the processor and the coprocessor to the sleep state within the predetermined time period.

Some aspects may include switching the plurality of subsystems into the sleep state, identifying by the coprocessor whether each of the plurality of subsystems has switched to the sleep state, and switching the processor and the coprocessor to the sleep state within the predetermined time period in response to identifying whether each of the plurality of subsystems has switched to the sleep state. Some aspects may further include receiving, by the processor, the sleep state request from a microcontroller of a vehicle based on a vehicle state change. In some aspects, switching the plurality of subsystems into the sleep state may include receiving, by the plurality of subsystems, a sleep state command from the processor, switching the plurality of subsystems to a low-power mode in response to the sleep state command, switching off interrupts by the plurality of subsystems in response to the sleep state command, and transmitting to the processor an acknowledgment confirming entry by each of the plurality of subsystems that entered into the sleep state. Some aspects may further include determining, by the processor, whether an acknowledgment confirming entry into the sleep state has been received from each of the plurality of subsystems, and transmitting a sleep state acknowledgment to the coprocessor from the processor in response to determining that acknowledgments have been received from each of the plurality of subsystems.

In some aspects, each of the plurality of subsystems may transmit to the processor a request to a reduced shared resource allocation in response to receiving the sleep state command. Some aspects may further include transmitting, from the coprocessor to the processor, a sleep state termination command upon determining that the sleep state acknowledgment has not been received by the coprocessor within the predetermined time period. In some aspects, a coprocessor clock of the coprocessor may be independent from a clock of the processor, and a coprocessor power supply may be independent from a power supply of the processor.

Further aspects include a computing device having a processor and co-processor configured to perform one or more operations of any of the methods summarized above. Further aspects include processing devices for use in a vehicle configured with processor-executable instructions to perform operations of any of the methods summarized above. Further aspects include a non-transitory processor-readable storage medium having stored thereon processor-executable instructions configured to cause a processor of a vehicle to perform operations of any of the methods summarized above. Further aspects include a vehicle having means for performing functions of any of the methods summarized above. Further aspects include a system on chip for use in a vehicle and that includes a processor configured to perform one or more operations of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a system diagram illustrating an example system suitable for implementing various embodiments.

FIG. 2 is a system diagram illustrating an example system architecture suitable for implementing various embodiments.

FIG. 3 is a system diagram illustrating an example system architecture suitable for implementing various embodiments.

FIG. 4 is a system diagram illustrating components suitable for implementing various embodiments.

FIG. 5 is an illustration of a timing diagram of an example system according to various embodiments.

FIG. 6 is an illustration of a timing diagram of an example system according to various embodiments.

FIG. 7 is a system block diagram illustrating an example system suitable for implementing various embodiments.

FIG. 8 is a process diagram illustrating an example method suitable for implementing various embodiments.

FIG. 9 is a process diagram illustrating an example method suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments provide methods and mechanisms for orderly shutdown and entry into low power modes for processors and co-processors that are interdependent. Managing entry of a computing device into a sleep state may include a plurality of subsystems executing on a processor, where at least a first subsystem of the plurality of subsystems is configured to: receive a sleep state request from a process executing in the processor; determine whether the first subsystem is in an operational state that permits entering the sleep state; and issue a trigger message in response to determining that the first subsystem is in an operational state that permits entering the sleep state. Managing entry of a computing device into a sleep state may include a co-processor connected to the processor and having a first timer, the co-processor configured to: receive the trigger message from the processor based on the determination of whether the first subsystem is in an operational state that permits entering the sleep state; start the first timer in response to receiving the trigger message from the processor, the first timer being associated with a predetermined time period; determine whether an acknowledgment of the sleep state has been received from each of the plurality of subsystems within the predetermined time period; and cause the processor and co-processor to enter the sleep state in response to an acknowledgment of the sleep state having been received within the predetermined time period. For security, the coprocessor may be supplied power by an independent coprocessor power supply, namely a power supply separate from the power supply for a main processor.

As the number of systems operating on a vehicle has increased and as information from those systems is being transmitted/received throughout the vehicle, the shutdown sequence for such a network of systems can easily fail. In vehicles, a shutdown may be initiated by removal of a key from the ignition, an on/off button press, or a wireless device falling out of range. Each of these triggers may abruptly shut down one or more systems of a vehicle. Various systems may be dependent on other systems and may not have coordinated mechanisms for shutdown. Furthermore, a shutdown of one or more of the processors in the vehicle system may trigger fatal errors or hard restarts at their corresponding co-processors. Likewise, a shutdown of a co-processor operating as a check for another processor may result in insecure failure modes or hard restarts for either or both of the processors instead of shutdowns.

The process of various embodiments manages the entry of a processor and a co-processor into a sleep state. This functionality is crucial for conserving energy when a vehicle is off and for preventing harmful failure modes. The computing device may include a processor and a co-processor, which each coordinate the sleep state management process so that both shutdown appropriately. The processor may include a number of subsystems which may be applications or other processes, which may execute on the processor. When a sleep state request is received, the subsystems may be individually configured to determine their operational state to ensure they can safely enter the sleep state. If a subsystem is ready, the subsystem confirms that status with an application management layer of the processor. Later, the processor may instruct the subsystems to enter a sleep mode. If one of the subsystems fails to enter the sleep mode, the processor may recognize that failure or receive indications of the failure so that the sleep state can be aborted in an orderly manner.

The co-processor may be powered by an independent power supply (i.e., a power supply separate from the power supply for a main processor) and include an independent clock. The co-processor may be configured with a timer and configured to receive the trigger message from the processor. Upon receipt of an acknowledgment that subsystems are able to enter sleep mode, the co-processor may start the timer and wait for an acknowledgment from the processor indicating that all subsystems have entered sleep within a predetermined time period. If all subsystem acknowledgments are received by the processor, the processor may indicate to the co-processor that the sleep state can be entered. As a result, the co-processor may cause both itself and the processor to enter the sleep state. The co-processor may indicate to an external controller or bus that the sleep state has been entered to alert other vehicle systems outside of its control of the altered state.

In some embodiments, the computing device may be integrated into a vehicle system. The processor or its subsystems may include an input/output component that receives vehicle states from a microcontroller. The processor or the subsystems may use this I/O information to manage the sleep state requests for the subsystems, adapting to the vehicle's operational needs. For example, if a subsystem is actively receiving requests from other vehicle systems (e.g., a microcontroller unit – MCU), then the subsystem may indicate that it cannot enter a sleep state if queried by the processor. Further, by entering a sleep state in an orderly and predictable manner, the vehicle’s battery power may be preserved. The computing device's sleep state management system may include a series of checks between different systems and various fail-over modes if checks fail.

Various embodiments address the problem of avoiding crashes and improving performance when entering a low-power mode in automotive system-on-chips (SoCs). The processes to solve this problem may include performing a plausibility check before attempting to enter the low-power mode, by sending a request to the subsystems and aggregating their responses. If any subsystem cannot enter the low power mode, the subsystem may inform the processor and the co-processor (safety island) of the failure, and either may abort the process. Further, by using a limbo mode timer by the co-processor to give a time-out point for the subsystem shutdown, the co-processor and processor may prevent inadvertently falling into intermediate states that do not progress. For example, if the limbo mode timer expires before the shutdown confirmation arrives, the low power mode entry may be reversed by the co-processor by waking up the processor and its subsystems. Having proper sleep state entry may ensure a wake-up from a warm boot instead of a cold boot when exiting the low-power mode, which may improve the responsiveness and integrity of the system.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general-purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores, or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. An SIP also may include multiple independent SOCs coupled together via high-speed communication circuitry and packaged in close proximity, such as on a single motherboard or in a single wireless device. The proximity of the SOCs facilitates high-speed communications and the sharing of memory and resources.

As used herein, the term “processing system” is used herein to refer to one or more processors, including multi-core processors, that are organized and configured to perform various computing functions. Various embodiment methods may be implemented in one or more of multiple processors within a vehicle processing system as described herein.

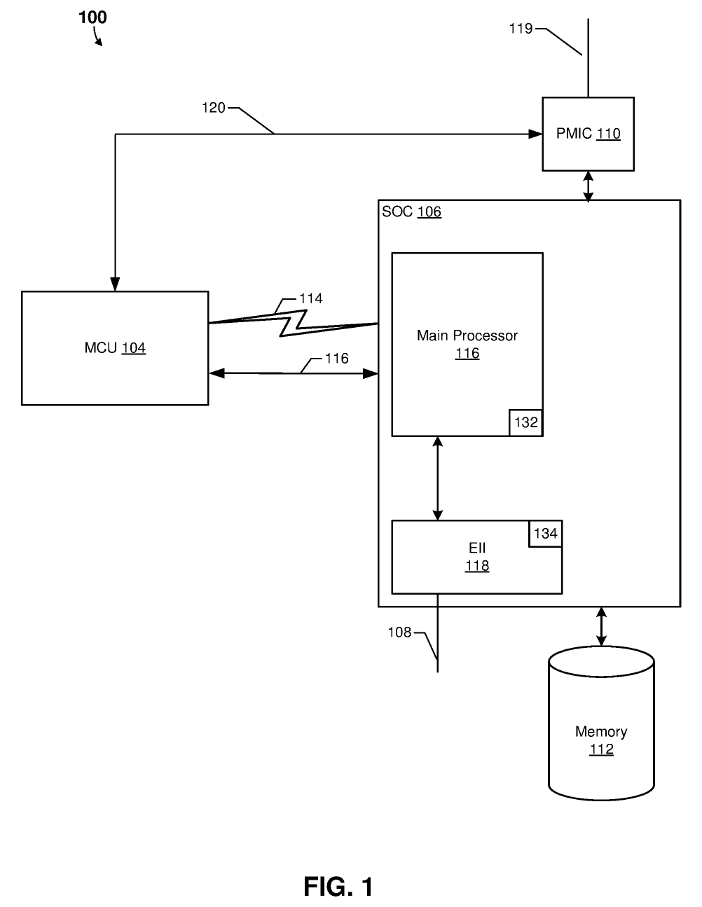

FIG. 1 is a component block diagram illustrating an example computing system 100 suitable for implementing any of the various embodiments. Various embodiments may be implemented on a number of single processor and multiprocessor computer systems, including a system-on-chip (SOC) or system in a package (SIP).

With reference to FIG. 1, the illustrated example computing system 100 (which may be a SIP in some embodiments) includes a SOC 106 coupled to a microcontroller unit (MCU) 104 via a common bus 116 (e.g., controller area network – CAN – bus). In some embodiments, the SOC 106 may connect wirelessly via wireless link 114 to the MCU 104. The SOC 106 may operate as a central processing unit (CPU) of a vehicle user interface that carries out the instructions of software application programs by performing the arithmetic, logical, control, and input/output (I/O) operations specified by the instructions.

The SOC 106 may include a main processor 116 and an electrically isolated island (EII) 118 and may connect to the power management integrated circuit (PMIC) 110 and a memory 112. The SOC 106 may include power connections to power supplies/voltage regulators via power connections 119 and 108 to independent power sources. The power connection 119 may connect to the PMIC 110 to power the SOC 106, including the main processor 116. A separate power source connection 108 to the EII 118 (also referred to herein as a coprocessor power supply) may be controlled by the EII 118 or an onboard power manager for the EII 118. Providing a power source connection 108 for a coprocessor power supply that is separate from the power connection 119 a power source for the SOC 106 may increase safety or reliability of the vehicle computing system 100. The EII 118 may include a system clock 134 separate from the clock 132 of the SoC 106 and may be synchronized with the SoC clock 132. The MCU 104 may connect to the PMIC 110 via an interface 120. For example, the MCU 104 may transmit a power OFF or ON request for turning OFF/ON the SOC 106 to the PMIC 110. The MCU 104 may inform the PMIC 104 that the vehicle has been turned OFF.

The memory 112 may be a random access memory (RAM), a static random access memory (SRAM), dynamic RAM (DRAM), or other memory types that may store one or more computer-executable instructions which may be executed by the SoC 106, main processor 116, and EII 118. The EII 118 may be a co-processor that may operate independently or semi-independently from the main processor 116 as a check on the processes of the main processor. For example, the EII 118 may indicate a failure or shutdown of the main processor 116 to the MCU 104.

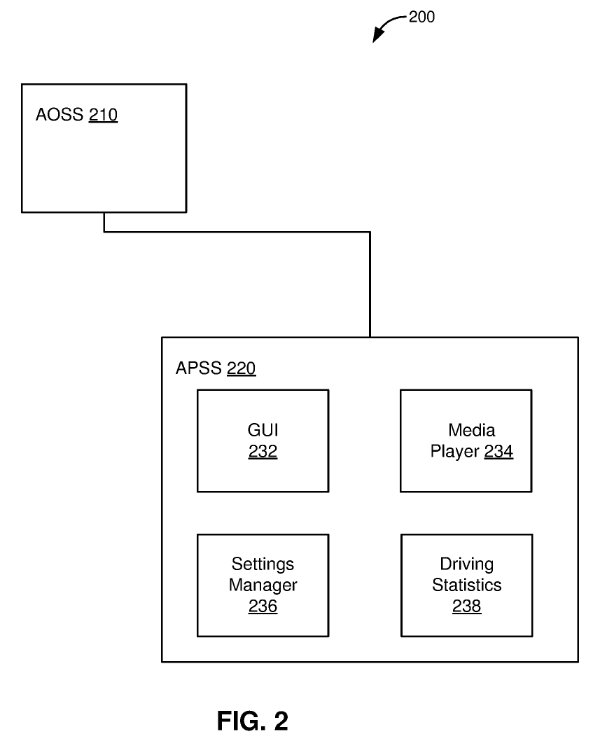

FIG. 2 is a component block diagram illustrating application components of an example computing system 200 suitable for implementing any of the various embodiments. With reference to FIGS. 1-2, the SoC 106 and the main processor 116 thereof may execute one or more computer-readable and executable instructions to provide one or more application layers and an operating system (OS). The SOC 106 may execute, starting at boot up, a lower-level component management process such as an always-on subsystem (AOSS) 210. The AOSS 210 may be a separate hardware block on the SoC 106. An always-on subsystem (AOSS) 210 may include a state machine that may record or control the operating states of one or more components on the SoC 106. At a higher level, the processor and the OS of the processor may execute an application processor subsystem (APSS) 220, which may interact with and control various applications or subsystems of the processor. The APSS 220 may manage communications including commands and acknowledgments between the EII 118, the AOSS 210, and the subsystems 232-238 of the processor.

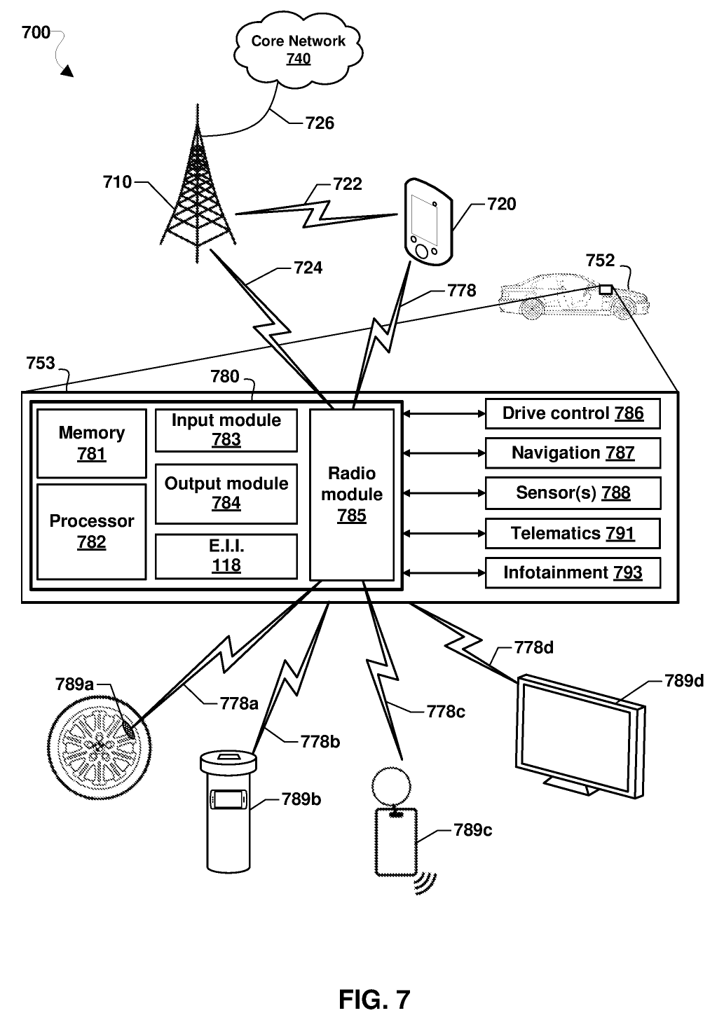

The subsystems 232-238 may include a graphical user interface (GUI) 232 that may display information to a driver of a vehicle, such as route information, tire pressure, vehicle speed, or other vehicle information. The subsystems 232-238 may include a media player 234 that may connect to one or more media devices to provide audiovisual media in a vehicle. The subsystems 232-238 may include a settings manager 236 that may integrate with vehicle subsystems such as driving assistance and vehicle controls such as sport mode, four-wheel drive mode, or other vehicle operation settings. The settings manager 236 may integrate with vehicle control systems such as the engine control unit (ECU) via a CAN bus or other common bus of the vehicle. The subsystems 232-238 may include a driving statistics subsystem 238 that may receive operating statistics and metrics from various vehicle systems such as the odometer or ECU (e.g., for fuel efficiency). The APSS 220 may connect to and communicate with various other subsystems of a vehicle, some examples of which are illustrated in FIG. 7.

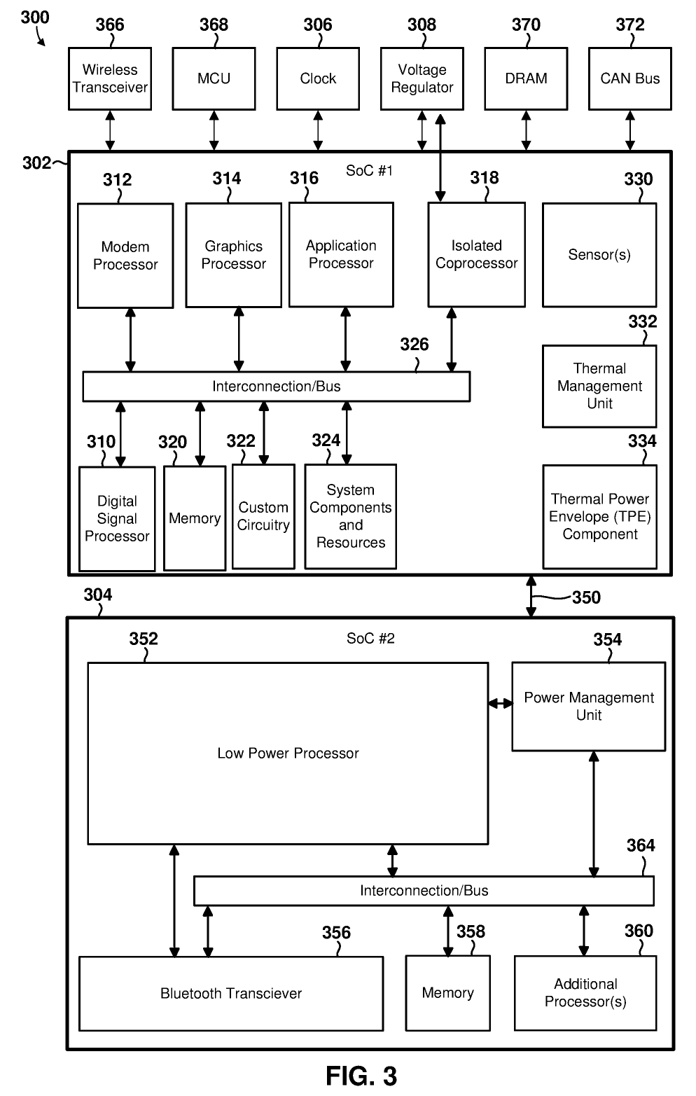

FIG. 3 is a component block diagram illustrating an example computing and wireless modem system 300 suitable for implementing any of the various embodiments. Various embodiments may be implemented on a number of single-processor and multiprocessor computer systems, including a system-on-chip (SOC) or system in a package (SIP).

With reference to FIGS. 1-3, the illustrated example computing system 300 (which may be an SIP in some embodiments) includes two SOCs 302, 304. The SoC 302 may be coupled to a clock 306, a voltage regulator 308, and a wireless transceiver 366 configured to send and receive wireless communications via an antenna (not shown) to/from a user device (e.g., 720, 789c) or a network device (e.g., 710), an MCU 368, a DRAM module 370, and a CAN bus 372. In some implementations, the first SOC 302 may operate as a central processing unit (CPU) of the UE that carries out the instructions of software application programs by performing the arithmetic, logical, control, and input/output (I/O) operations specified by the instructions. In some implementations, the second SOC 304 may operate as a specialized processing unit. For example, the second SOC 304 may operate as a specialized 5G processing unit responsible for managing high volume, high speed (such as 5 Gbps, etc.), and/or very high frequency (VHF) short wavelength (such as 28 GHz mmWave spectrum, etc.) communications.

The first SOC 302 may include a digital signal processor (DSP) 310, a modem processor 312, a graphics processor 314, an application processor 316, an isolated coprocessor 318 (e.g., EII) connected to one or more of the processors, and to voltage regulator 308, memory 320, custom circuity 322, system components and resources 324, an interconnection/bus module 326, one or more temperature sensors 330, a thermal management unit 332, and a thermal power envelope (TPE) component 334. The isolated coprocessor 318 may connect to a debug port of the SOC 302 to continuously monitor processes and clock signals of the SOC.

The second SOC 304 may include a low-power processor 352, a power management unit 354, an interconnection/bus module 364, a BLUETOOTH transceiver 356, memory 358, and various additional processors 360, such as an applications processor, packet processor, etc. These transceivers and processors may be configured to receive information from an outside network (e.g., a user device such as a cellphone) or from other vehicles. The BLUETOOTH transceiver 356 may connect to a user’s key to the vehicle to initiate remote start or other remote capabilities.

Each processor 310, 312, 314, 316, 318, 352, 360 may include one or more cores, and each processor/core may perform operations independent of the other processors/cores. For example, the first SOC 302 may include a processor that executes a first type of operating system (such as FreeBSD, LINUX, OS X, etc.) and a processor that executes a second type of operating system (such as MICROSOFT WINDOWS 10). In addition, any or all of the processors 310, 312, 314, 316, 318, 352, 360 may be included as part of a processor cluster architecture (such as a synchronous processor cluster architecture, an asynchronous or heterogeneous processor cluster architecture, etc.).

The first and second SOC 302, 304 may include various system components, resources, and custom circuitry for managing sensor data, analog-to-digital conversions, wireless data transmissions, and for performing other specialized operations, such as decoding data packets and processing encoded audio and video signals for rendering in a web browser or GUI (e.g., GUI 232). For example, the system components and resources 324 of the first SOC 302 may include power amplifiers, voltage regulators, oscillators, phase-locked loops, peripheral bridges, data controllers, memory controllers, system controllers, access ports, timers, and other similar components used to support the processors and software clients running on a UE. The system components and resources 324 and/or custom circuitry 322 also may include circuitry to interface with peripheral devices, such as cameras, electronic displays, wireless communication devices, external memory chips, etc.

The first and second SOC 302, 304 may communicate via an interconnection/bus module 350. The various processors 310, 312, 314, 316, 318, may be interconnected to one or more memory elements 320, system components and resources 324, and custom circuitry 322, and a thermal management unit 332 via an interconnection/bus module 326. Similarly, the processor 352 may be interconnected to the power management unit 354, the BLUETOOTH transceiver 356, memory 358, and various additional processors 360 via the interconnection/bus module 364. The interconnection/bus module 326, 350, 364 may include an array of reconfigurable logic gates and/or implement a bus architecture (such as CoreConnect, AMBA, etc.). Communications may be provided by advanced interconnects, such as high-performance networks-on-chip (NoCs).

The first and/or second SOCs 302, 304 may further include an input/output module (not illustrated) for communicating with resources external to the SOC, such as a clock 306 and a voltage regulator 308. Resources external to the SOC (such as clock 306, voltage regulator 308) may be shared by two or more of the internal SOC processors/cores. The voltage regulator 308 may provide separate power rails for SOC 302, SOC 304 and isolated coprocessor 318. Further, the second SOC 304 may include an isolated coprocessor (electrically isolated island/safety island) as one of the additional processors 360 so as to comply with one or more vehicle standards, including Automotive Open System Architecture (AUTOSAR) and International Organization for Standardization (ISO) 26262.

In addition to the example SIP 300 discussed above, some embodiments may be implemented in a wide variety of computing systems, which may include a single processor, multiple processors, multicore processors, or any combination thereof.

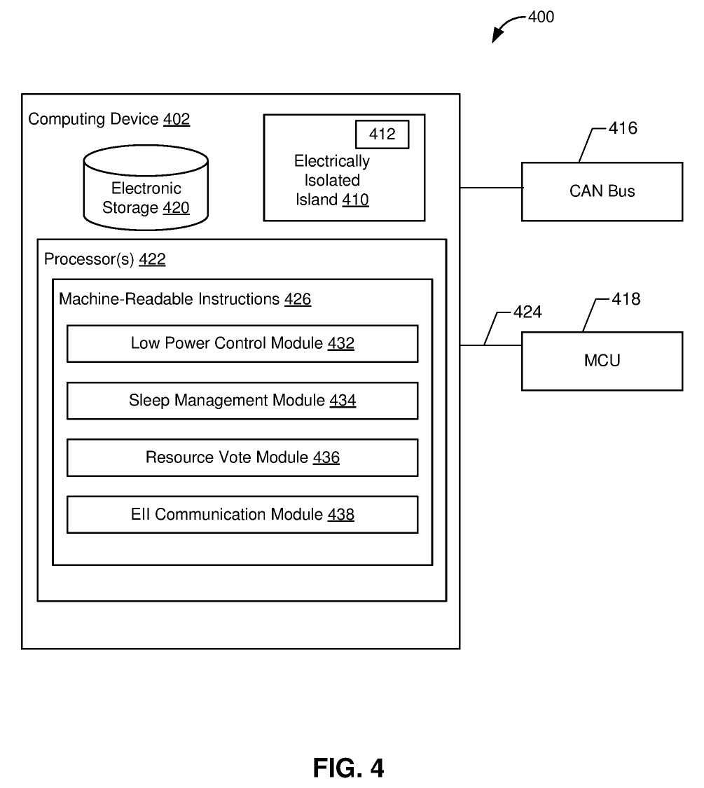

FIG. 4 is a system block diagram illustrating an example system suitable for implementing the methods of various embodiments. With reference to FIGS. 1-4, the system 400 may include an MCU 418 configured to communicate with computing device 402 via a connection 424. The computing device 402 may also be embedded with peripherals in a vehicle and connect via a wired connection including via a CAN bus 416. A CAN bus 416 may be a common bus for communication with various vehicle systems, including diagnostic systems and driver assistance systems. The connection 424 to MCU 418 may connect to one or more microcontrollers that enable advanced driver assistance systems (ADAS) or intelligent speed assistance systems (ISA).

The computing device 402 may include one or more processor(s) 422, electronic storage 420, an electrically isolated island (EII) 410 with an EII clock 412, and other components. The computing device 402 may include communication lines or ports to enable the exchange of information with a network and/or other computing platforms. The illustration of the computing device 402 in FIG. 4 is not intended to be limiting. The computing device 402 may include a plurality of hardware, software, and/or firmware components operating together to provide the functionality of the computing device 402 in various embodiments.

Electronic storage 420 may include non-transitory storage media that electronically stores information. The electronic storage media of electronic storage 420 may include one or both of system storage that is provided integrally (i.e., substantially non-removable) with the computing device 402 and/or removable storage that is removably connectable to the computing device 402 via, for example, a port (e.g., a universal serial bus (USB) port, a firewire port, etc.) or a drive (e.g., a disk drive, etc.). Electronic storage 420 (e.g., memory 112) may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 420 may include one or more virtual storage resources (e.g., cloud storage, a virtual private network, and/or other virtual storage resources). Electronic storage 420 may store software algorithms, information determined by processor(s) 422, information received from the computing device 402 or MCU 418, information received from CAN bus 416, and/or other information that enables the computing device 402 to function as described herein.

The electrically isolated island 410 may be an automotive safety island configured to manage and control safety aspects on an SoC (e.g., 106) by signaling failures, enabling quick device recovery, checksum packet inspection, and auto-debugging. The EII 410 may prevent real-world harm from resulting from the failure of safety-critical systems in a vehicle by detecting random hardware faults and failing over into manual modes or safer modes. The EII 410 may include logic to detect faults via a memory Built-In Self-Test (BIST) and embedded analytics for cybersecurity monitoring. The EII 410 may be logically, physically, and power-separated from the rest of the SoC to ensure constant safety management.

The processor(s) 422 may include one or more local processors, which may be configured to provide information processing capabilities in the computing device 402 (or MCU 418). As such, the processor(s) 422 may include one or more of a digital processor, an analog processor, a digital circuit designed to process information, an analog circuit designed to process information, a state machine, and/or other mechanisms for electronically processing information. Although the processor(s) 422 is shown in FIG. 4 as a single entity, this is for illustrative purposes only. In some embodiments, the processor(s) 422 may include a plurality of processing units. These processing units may be physically located within the same device, or the processor(s) 422 may represent the processing functionality of a plurality of devices operating in coordination.

The computing device 402 may be configured by machine-executable instructions 426, which may include one or more instruction modules. The instruction modules may include computer program components. In particular, the instruction modules may include one or more of a low power control module 432, a sleep management module 434, a resource vote module 436, an EII communication module, and/or other instruction modules. Together, these components (e.g., 432-438) of a computing device 402 may provide a coordinated process between the processor(s) 422 and the EII 410 to safely shut down the computing device into a deep sleep mode that includes low power mode entry for the subsystems of the processor(s) 422.

The low power control module 432 may be connected with various subsystems of the computing device 402 to manage entry of each of the subsystems into a low power mode. The low power control module 432 may receive messages, acknowledgments, and notifications from any of the components and subsystems that are configured to have a low power mode. The low power control module 432 may include a state machine that records the low power state (YES/NO) for various subsystems and informs other SoC components about these states. For example, the machine-readable instructions 426, including an OS, may send, to the low power control module 432, a request to have the subsystems enter low power mode. This request may be sent along to each of the subsystems by the low power control module 432 and their responses may be collected by the low power control module 432. Each of the subsystems may include program logic that checks I/O ports, memory, and other aspects of the process of the subsystem to determine whether the subsystem is able to enter low power mode. In some implementations, the low power control module 432 may conduct checks of one or more subsystems to determine whether the subsystem is able to enter low power mode, including checks of I/O ports, memory, and other aspects of the subsystem. The low power control module 432 may operate as part of the APSS 220.

The sleep management module 434 may operate to manage a deeper level of low power mode (i.e., a lower low power mode for the whole SoC) for the subsystems and the processor(s) 422 themselves. The sleep management module 434 may coordinate with the low power control module 432 and the EII 410 to enter the computing device 402 into a sleep state that reduces power by the power management controller. The sleep management module 434 may operate as part of the AOSS (e.g., 210) to coordinate the hardware component power down of the computing device 402 as a whole to a sleep state. The sleep management module 434 may monitor or record the sleep state or usage of one or more components such as memory (e.g., electronic storage 420). The sleep management module 434 may connect to an aggregate resource controller (ARC) that, during normal operation, receives and records resource votes from subsystems that require shared resources on the SoC (e.g., memory). Based on the pending resource votes from each subsystem, the sleep management module 434 may determine whether each subsystem is able to enter sleep mode. For example, a sleep mode for a subsystem may include disabling wakeup interrupts, including I/O interrupts, and may include entry into low power mode. A subsystem in sleep mode may remove all shared resource votes from the ARC.

As a non-limiting example, the processor(s) 422 of the computing device 402 may evaluate the resources being used and when all subsystems have removed their resource requests, the processor 422 may power down to a sleep state in coordination with the EII 410. The MCU 418 may connect to the computing device 402 via connection 424, and the computing device 402 may transmit shutdown commands, receive fail-over notifications from the EII 410, and receive confirmation of the sleep state of the computing device 402.

The resource vote module 436 may include the aggregate resource controller (ARC) and may operate as part of the AOSS (e.g., 210). The resource vote module 436 may receive and record resource votes from subsystems that require shared resources on the SoC (e.g., memory). In some implementations, the resource vote module 436 may include submodules at each subsystem that may determine the resource needs of each respective subsystem and the submodules may submit resource votes to the resource vote module 436. The resource vote module 436 may be queried for which subsystems have pending or ongoing resource requests.

The EII communication module 438 may manage communication between the main processor of a computing device 402 (SoC) and an EII 410, where the main processor and other functionality sharing a clock with the main processor may be referred to as the “main domain” of the computing device, and where the EII and other functionality sharing a clock with the EII coprocessor may be referred to as the “safety island” domain. The EII communication module 438 may ensure secure, synchronized communication between these two domains with different clocks. The EII communication module 438 may receive messages, acknowledgments, commands, and queries from the subsystems, the APSS (e.g., 220), and the AOSS (e.g., 210). The EII communication module 438 may receive messages, acknowledgments, commands, and queries from the EII 410 for transmission to other components of the computing device 402 (e.g., SoC 106) or for transmission outside the computing device 402 (e.g., for sleep confirmations, or fault signals).

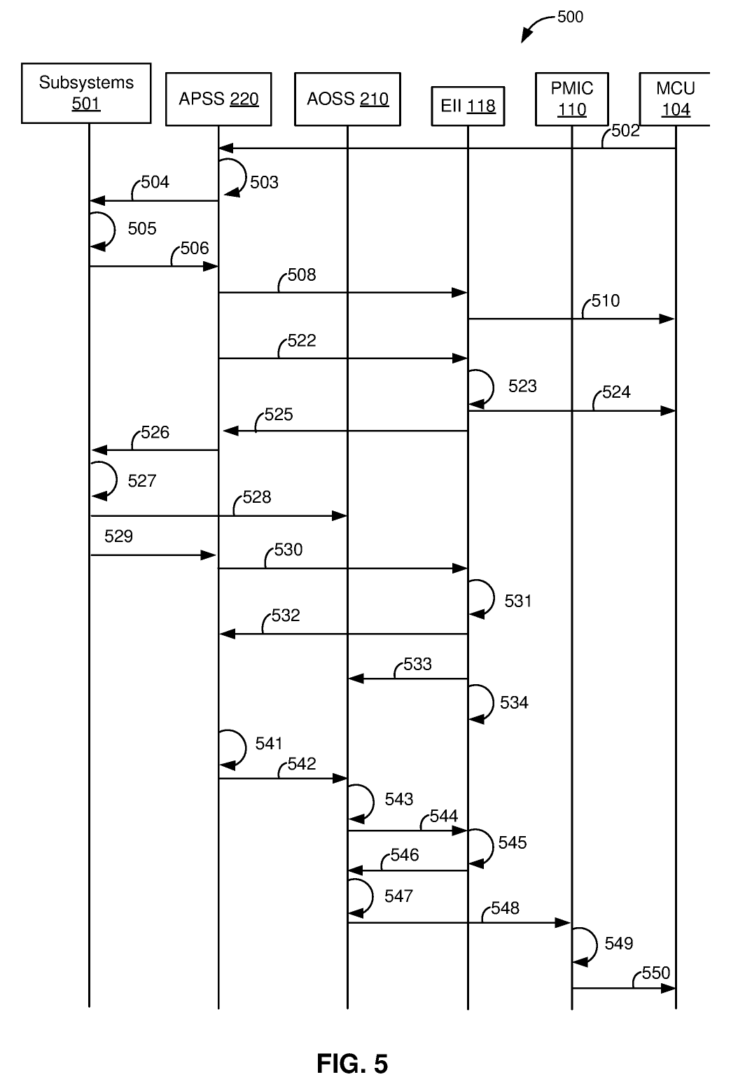

FIG. 5 is a signal diagram illustrating a timing diagram 500 suitable for implementing various embodiments. With reference to FIGS. 1-5, FIG. 5 illustrates operations for coordinating aspects of the joint sleep entry of the main processor (e.g., 112) and the EII coprocessor (e.g., 118). At 502, the APSS 220 of and SoC (e.g., 106) may receive a message 502 from MCU 104 (e.g., ignition control unit) indicating that an ignition of the vehicle has been turned off. Based on this trigger, the APSS 220 may determine which type of low power mode to enter as part of decision 503. For example, if the ignition off notification was the result of the key going out of range, the APSS 220 may determine that a deep sleep is not immediately appropriate. For example, if the user manually turns off the vehicle, the APSS 220 may determine that a sleep state is appropriate to save battery life.

In signal 504, after determining that a sleep state is appropriate, the APSS 220 may signal each of the subsystems with a request that each subsystem check whether the subsystem can be put in a low power mode (LPM) or sleep mode. This LPM check 505 may include checking whether the subsystem is performing any critical processing or has outstanding requests from other systems of the vehicle. A critical request or critical process may be a request or process for a system classified as critical (e.g., under ISO 26262). Each subsystem may then transmit an ACK or NACK signal 506 back to the APSS 220 based on whether the LPM check indicated the sleep mode was possible or not, respectively.

If one of the subsystems is not able to enter LPM mode and transmits a NACK as signal 506, then the APSS 220 may determine that a sleep state cannot be entered by the computing device. The APSS 220 may then indicate to the EII 118 in message 508 that the sleep state entry has failed. The EII 118 may then inform the MCU 104 (or a different MCU) that the sleep state has failed for the computing device (e.g., SoC) in a fault message 510.

If all the subsystems are able to enter the LPM mode and all transmit ACK messages 506 to the APSS 220, then the APSS 220 may transmit a message 522 to the EII 118 (e.g., via EII communication module 438) to stop safety monitoring in preparation for sleep state entry for the computing device. The EII 118 may perform this request as process 523 and may confirm to the MCU 104 via message 524 that sleep state entry has begun. The EII 118 may then acknowledge in an ACK message 525 to the APSS 220 as well that sleep state entry has begun on the EII domain side.

Based on the acknowledgment from the EII 118, the APSS 220 may command the subsystems 501 to enter the LPM mode in command 526. Note that the signal 504 is a command to check for LPM viability and ultimately sleep state viability.

In process 527, the subsystems 501 may each switch into low power mode (LPM) and may switch off or disable wakeup or trigger interrupts that take them out of LPM. Together these may be referred to herein as a sleep state for the subsystems 501. The subsystems 501 may then each transmit a signal 528 to the AOSS 210 that removes their resource votes (requests) for the shared resources of the computing device (SoC), such as via resource vote module 436. The subsystems 501 may also transmit an ACK message 529 back to the APSS 220 to confirm that they have each entered a sleep state.

Once the subsystems 501 have entered LPM mode and will not be woken up or interrupted, the APSS 220 may transmit an LPM command 530 to the EII 118. In process 531, the EII 118 may complete any current tasks or requests and then may enter a low-power mode. The EII 118 may then transmit an ACK 532 to the APSS 220 confirming that the LPM has been entered by the EII 118. Various interrupts and wake-up triggers may remain active and enabled for the EII 118 in LPM mode, as further actions may need to be taken by the EII 118 as described below.

The EII 118 may transmit a message/request 533 to the AOSS 210 removing resource votes for shared resources of the computing device (SoC). The EII 118 may initiate a limbo mode timer in process 534 with a predefined time limit. The EII 118 may be configured to exit LPM mode automatically if the limbo mode timer expires. The operations and signals 522-534 may occur when all subsystems are capable of LPM entry and each of them successfully enters the LPM along with the EII 118. Failure of any of these processes may result in a fail-over process in which the EII 118 may transmit a fault message (e.g., similar to message 524).

Further, if the sleep state entry of the main domain side (main processor side including subsystems 501, APSS 220, and AOSS 210) is successful and the EII 118 has entered low power mode, the APSS 220 may enter the LPM mode in process 541. The APSS 220 may transmit a request 542 to the AOSS 210 to remove shared resource votes from shared resources. In response, the AOSS 210 may execute a shutdown process 543 that collapses (refreshes) the shared memory of the computer device and a voltage rail requirement reduction, which may be performed via the aggregate resource controller (ARC) and a power controller thereof. A control logic (CX) domain and a memory (MX) domain of the computing device may be powered down and enter an LPM mode as part of process 543, as controlled by the ARC.

The AOSS 210 may transmit a handshake message 544 to an application power mux (APM) switch of the EII 118, which may reset the limbo mode timer in process 545. Once the APM switch has been executed by the EII 118, the EII 118 may reset the limbo mode timer. Once the APM switch has been executed by the EII 118, the EII 118 may transmit an ACK message 546 to the AOSS 210 confirming the APM switch (i.e., voltage reduction).

In process 547, the AOSS 210 may execute an awake-sleep state manager (AWSM) that may manage the AOSS 210 and the main domain side of the computing device during sleep. Once the AWSM is fully operational, the AOSS 210 may transmit a PMIC boot sequence (PBS) trigger 548 to the PMIC 110 to reduce a power or voltage level.

In process 549, the PMIC 110 may execute the boot sequence, which may finalize and establish the sleep state for the entire computing device (e.g., SoC 106, 302). The sleep state for the computing device may include respective low power modes being enabled for the subsystems 501, the APSS 220, the AOSS 210, and the EII 118. The PMIC 110 may then transmit an ACK message 550 to the MCU 104 (or another MCU) to confirm that the computing device has entered a sleep state. The PMIC 110 may thereby notify the rest of the vehicle systems so that they do not expect responses from the computing device.

The operations and signals 541-550 may be performed by the computing device if the subsystems 501 have already successfully entered a sleep state. In other words, operations and signals 541-550 may be performed if operations 502-506 have been performed and all subsystems are LPM ready and if operations 522-534 have been performed successfully.

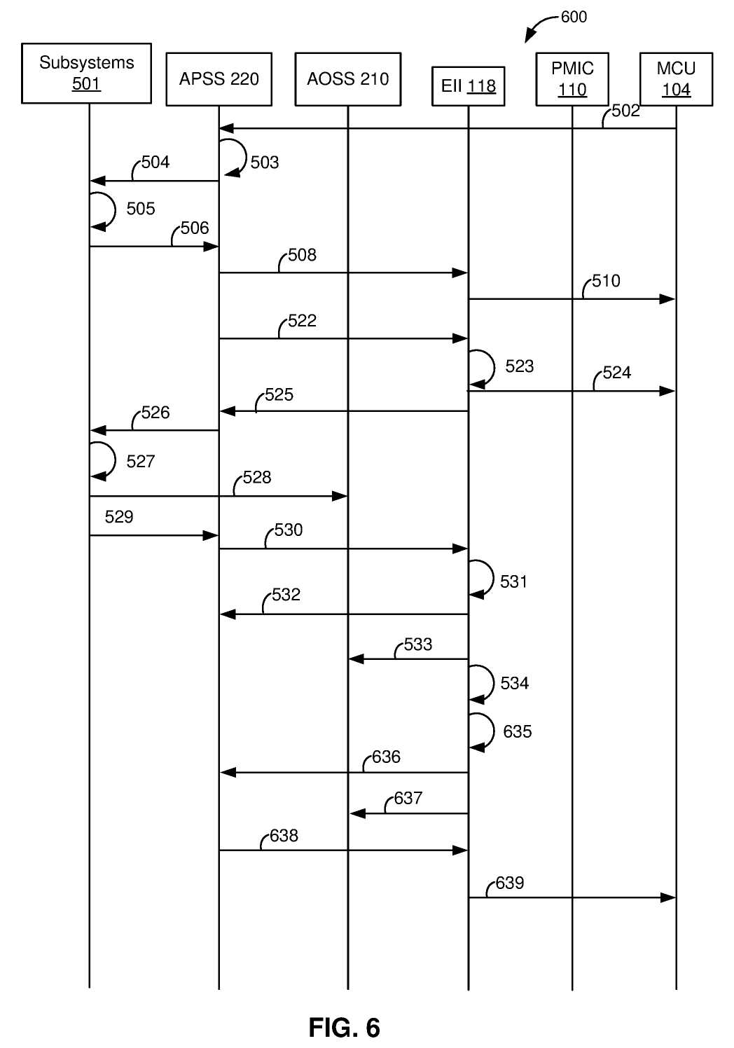

FIG. 6 is a signal diagram illustrating a timing diagram 600 suitable for implementing various embodiments. With reference to FIGS. 1-6, FIG. 6 illustrates the operations for coordinating aspects of the joint sleep entry of the main processor (e.g., 112) and the EII coprocessor (e.g., 118). Operations 502-534 of FIG. 6 may correspond to those operations 502-534 described in FIG. 5.

In some cases, operations 502-506 may have been performed, all subsystems may be LPM-ready, and operations 522-534 have been performed successfully such that the limbo mode timer has started. In such conditions, a failure in the APSS 220 or AOSS 210 to enter an LPM mode may delay or halt the progression of operations 541-544 such that the APM switch command 544 is not sent before the limbo mode timer expires in operation 635. Any of operations 541-544 of FIG. 5 may fail after the limbo mode timer is set in process 534, which may then result in the limbo mode timer expiring in operation 635. For example, a subsystem 501 may awaken due to a priority signal or internal subsystem awake timer, resulting in the subsystem and APSS 220 requiring resources and preventing entry into the sleep mode or LPM mode when needed in operation 541.

In such conditions, the EII 118 may send a trigger signal 636 to wake up the APSS 220 if it has entered a sleep mode. In response, the EII 118 may request resources (vote resources) in operation 637 from the shared resources via the ARC of the AOSS 210. Once the APSS 220 is back in operation, the APSS 220 may transmit an ACK message 638 to the EII 118 confirming that it is back in operation. The EII 118, the APSS 220, and the rest of the main domain components may then restart normal operation or may individually enter low power mode, as the case may be. The EII 118 may inform the MCU 104 (or another MCU) that the entry into a sleep mode for the computing device has failed with a functional safety fault message 639. Thus, operations 508-510 and 635-639 may correspond to operations that occur when the sleep mode entry process described herein fails at different points.

FIG. 7 is a component block diagram illustrating an automotive network 700 of components and support systems suitable for implementing various embodiments. Various embodiments (including embodiments discussed above with reference to FIGS. 1-6 and 8) may be implemented in a variety of vehicle computing devices, an example of which is illustrated in FIG. 7 in the form of vehicle computing system 753. With reference to FIGS. 1-7, a vehicle 752 may include a user subsystem 780, which may include various circuits and devices used to control the operation of the vehicle 752 as well as communicate with other vehicles that are similarly equipped. In the example illustrated in FIG. 7, the user subsystem 780 includes a radio module 785, a processor 782, memory 781, an input module 783, an output module 784, and an EII 118. The user subsystem 780 may be coupled to and configured to control drive control components 786, navigation components 787, one or more sensor components 788 of the vehicle 752, telematics components 791, and infotainment components 793.

A base station 710 may communicate with the core network 740 over a wired or wireless communication link 726. The wireless communication link 726 may use a variety of wired networks (e.g., Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

A wireless computing device 720 and vehicle 752 may communicate with the base station 710 over wireless communication links 722 and 724. The wireless communication links 722 and 724 may include a plurality of carrier signals, frequencies, or frequency bands, each of which may include a plurality of logical channels. The wireless communication links 722 and 724 may utilize one or more radio access technologies (RATs).

Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system include medium-range protocols such as Wi-Fi, LTE-U, LTE-Direct, LAA, MuLTEfire, and relatively short-range RATs such as ZigBee, Bluetooth, and Bluetooth Low Energy (BLE). In some embodiments, the wireless communication links 722 and 724 may include direct connection communication links that may be established over a PC5 interface in accordance with applicable 3GPP standards.

The user subsystem 780 may include a processor 782 that may be configured with processor-executable instructions to control maneuvering, navigation, and/or other operations of the vehicle 752, including operations of various embodiments. The processor 782 may be coupled to the memory 781, EII 118, and the radio module 785, for example, through an interconnection or bus (e.g., advanced eXtensible interface (AXI)). The processor 782 may include one or more processing units. In some embodiments, the processor 782 may be a network-on-chip (NoC), a switch, or a trusted integrated circuit (TIC) that may be communicatively coupled or connected to various network-capable devices within the vehicle network 700 (i.e., via the radio module 785).

The EII 118 may include an independent clock, connect to an independent power source, and connect to a debug port of the user subsystem 780 for real-time security analysis of the user subsystem.

The radio module 785 may be configured for wireless communications, including implementing operations of various embodiments. The radio module 785 may exchange wireless signals via wireless communication link 722 with a base station 710 and via wireless communication link 724 with control units in other vehicles. In some embodiments, the radio module 785 may also enable the vehicle 752 to communicate with a wireless communication device 720 (e.g., cellular phone) through a bidirectional wireless communication link 778, such as a WiFi or Bluetooth wireless data link (e.g., using a BLUETOOTH transceiver 356). Similarly, the radio module 785 may enable the processor 782 to transmit and receive information to and from various network devices 789a-789d within the vehicle network 700 via the wireless communication links 778a-778d.

The network devices 789 may be any device capable of communicatively coupling to the radio module 785 within the vehicle network 700, such as a wireless charging station 789b, a key fob or device for keyless entry 789c, infotainment systems 789d, cellular devices (e.g., 720), tire pressure measurement systems 789a, and satellite-based navigation systems (e.g., the Global Positioning System (GPS)). The provided examples of network devices 789 in communication with the radio module 785 are limited only for conciseness and are not intended to be exhaustive. In various embodiments, network devices under control may include environmental monitors and environmental control systems, various Internet of Things devices, and any other suitable device(s) capable of communicating with the radio module 785.

In various embodiments, the wireless communication links 722, 724, 778 may implement any various known wireless communications protocols and standards, such as Radio Frequency for Consumer Electronics (RF4 CE), Controller Area Network (CAN), long-range protocols such as 3GPP LTE, 3G, 4G, 5G (e.g., NR), GSM, CDMA, WCDMA, WiMAX, TDMA, any other mobile telephony communication technologies cellular RATs, medium range protocols such as Wi-Fi, LTE-U, LTE-Direct, LAA, MuLTEfire, relatively short range RATs such as ZigBee, Bluetooth, BLE, DigRF, any other communications based on Institute of Electrical and Electronics engineers (IEEE) 802 standards (e.g., IEEE 802.3), infrared (IR) communications protocols such as RECS-80, RC-5, RC-6, NEC/Renesas protocol, or any other suitable IR communication protocol. In some embodiments, various network devices 789 may be connected directly to the user subsystem 780 via a wired connection implementing one or more communication protocols such as Ethernet, Recommended Standard (RS)-232, RS-485, Universal Asynchronous Receiver Transmitter (UART), Universal Synchronous/Asynchronous Receiver/Transmitter (USART), Universal Serial Bus (USB), High Definition Multimedia Interface (HDMI), or any other suitable wired communications protocol.

The user subsystem 780 may be an Advanced Driver Assistance Systems (ADAS), and the wireless communication links 722, 724, 778, in conjunction with the user subsystem 780 (e.g., processor 782, radio module 785, and EII 118, etc.). As such, the user subsystem 780 may implement safety and/or standardized protocols as prescribed in the AUTOSAR, including but not limited to Automotive Hardware Functional Safety (FuSa) Features (e.g., ISO 26262), any Consultative Committee for International Telegraphy and Telephony (CCITT), algorithms for serial streams (e.g., Wide Area Network (WAN), radio communication protocol, Secure Digital, DigRF, etc.), AUTOSAR cyclic redundancy check (CRC) standards and recommended protocols such as AUTOSAR safety polynomial CRC32P4 with 0xF4ACFB13 polynomial, Society of Automotive Engineers (SAE) J1850 CRC8 for 0x1D polynomial used for diagnostics and data sharing applications in vehicles, and 8-bit 0x2F CRC for open safety communication protocol.

The input module 783 may receive sensor data from one or more sensor components 788 as well as electronic signals from other components, including the drive control components 786 and the navigation components 787. The output module 784 may be used to communicate with or activate various components of the vehicle 752, including the drive control components 786, the navigation components 787, and the sensor(s) 788. Input module 783, output module 784, and radio module 785 may be subsystems (e.g., 501) of an SoC. The components 786, 787, 788, 791, and 793 may connect to the user subsystem 780 as MCUs (e.g., 104).

The user subsystem 780 may receive and transmit analog and/or digital sensor data from and to the sensor components 788 and may be configured to communicate with the sensor components 788 unilaterally and/or bidirectionally. The user subsystem 780 in conjunction with the sensor components 788 may be in communication with network devices (e.g., wireless computing device 720, network devices 789a-d) configured to relay sensor information of the network devices. The user subsystem 780, in conjunction with the sensor components 788, may be configured to implement features such as electric vehicle (EV) wireless charging, keyless entry, phone-as-key, automated parking, tire pressure monitoring, remote sensor control, and automated driving features such as lane and brake checking and alerts.

The user subsystem 780 may be coupled to the drive control components 786 to control physical elements of the vehicle 752 related to maneuvering and navigation of the vehicle, such as the engine, motors, throttles, steering elements, flight control elements, braking or deceleration elements, and the like.

The user subsystem 780 may be coupled to the navigation components 787 and may receive data from the navigation components 787 and be configured to use such data to determine the present position and orientation of the vehicle 752, as well as an appropriate course toward a destination.

The user subsystem 780 may be coupled to the telematics components 791. The user subsystem 780 may receive and transmit data from and to the telematics components 791, and may be configured to, in conjunction with the telematics components 791, transmit and receive information between base stations (e.g., 710) and other vehicles. The user subsystem 780 in conjunction with the infotainment components 793 may be configured to provide features such as implementing Car2Car and Car2Infrastructure standards, LTE Offload, Media Services, over-the-air (OTA) updating, and general Internet access.

The user subsystem 780 may be coupled to the infotainment components 793. The user subsystem 780 may receive and transmit data from and to the infotainment components 793 and may be configured to stream data such as video and/or audio media to a display or media output unit of a communicatively connected network device (e.g., wireless computing device 720, network devices 789). The user subsystem 780, in conjunction with the infotainment components 793, may be configured to provide features such as hands-free voice calling, music streaming, multimedia distribution, rear-seat entertainment systems, display sharing, Apple CarPlay, Android Auto, MirrorLink, and general Internet access.

The processor 782 and/or the navigation components 787 may be configured to communicate with a core network 740 (e.g., the Internet) using a wireless communication link 722 with a cellular data network base station 710. The processor 782 may also be configured to perform a variety of software application programs by executing processor-executable instructions in an application layer as described herein.

While the user subsystem 780 is described as including separate components, in some embodiments, some or all of the components (e.g., the processor 782, the memory 781, the input module 783, the output module 784, and the radio module 785) may be integrated into a single device or module, such as a system-on-a-chip (SoC) or system-in-package (SiP) processing device, such as described with reference to FIG. 3. Such an SoC or SiP processing device may be configured for use in vehicles and be configured, such as with processor-executable instructions executing in the processor 782, to perform operations of various embodiments when installed into a vehicle.

In some implementations, the vehicle network 700 may include one or more devices configured to communicate as part of an intelligent transportation system (ITS). ITS technologies may increase intercommunication and safety for driver-operated vehicles. The cellular vehicle-to-everything (C-V2X) protocol defined by the 3rd Generation Partnership Project (3GPP) supports ITS technologies and serves as the foundation for vehicles to communicate directly with the communication devices around them. C-V2X defines transmission modes that provide non-line-of-sight awareness and a higher level of predictability for enhanced road safety. Such C-V2X transmission modes may include V2V, V2I, and V2P, and may utilize frequencies in a 5.9 gigahertz (GHz) spectrum that is independent of a cellular network. C-V2X transmission modes may also include vehicle-to-network communications (V2N) in mobile broadband systems and technologies, such as 3G mobile communication technologies (e.g., GSM evolution (EDGE) systems, CDMA 2000 systems, etc.), 4G communication technologies (e.g., LTE, LTE-Advanced, WiMAX, etc.), as well as 5G systems.

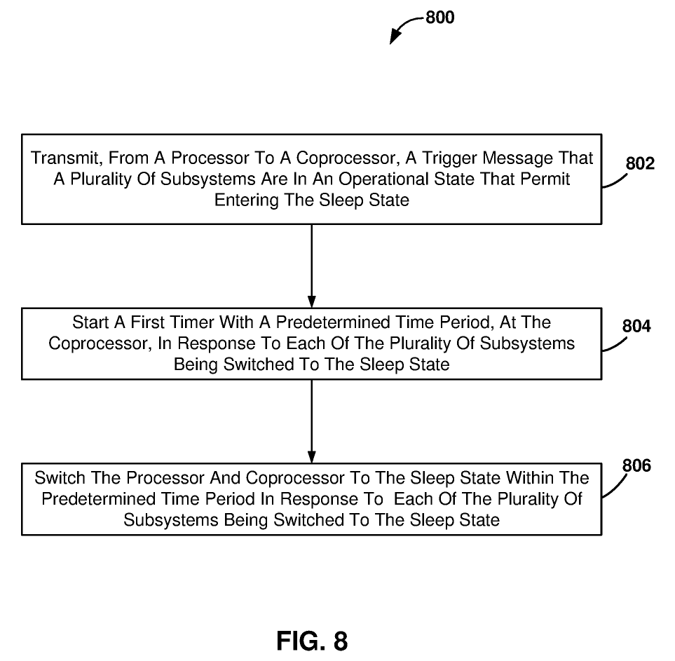

FIG. 8 is a process diagram illustrating an example method 800 suitable for implementing various embodiments. The operations of the method 800 may be performed by the computing device 320, SoC 106, SoC 302, or one or more components thereof (e.g., machine-readable instructions 426, processor(s) 422). In some embodiments, the vehicle may include a processor (e.g., processor 106, 422) configured to perform the operations by processor-executable instructions stored in a non-transitory processor-readable medium (e.g., memory 420, 112). Means for performing the operations of the method 800 may be a processing system (e.g., 100, 200, 300, 400) including one or more processors (e.g., 422), a wireless transceiver (e.g., 366, 352), and other components described herein. To encompass any of the processor(s), coprocessors, hardware elements, and software elements that may be involved in performing the method 800, the elements performing method operations are referred to as a “processing system”.

In block 802, the processing system may transmit, from the processor to the coprocessor, a trigger message in response to determining that the plurality of subsystems are in an operational state that permit entering the sleep state. In some embodiments, the processing system may only transmit the trigger message if all of the plurality of subsystems are in an operational state that permits entering the sleep state.

In block 804, the processing system, such as the coprocessor, may start a first timer with a predetermined duration or time period in response to the plurality of subsystems being switched to the sleep state. The first timer (e.g., a limbo mode timer) may be configured with a predetermined duration or time period that matches the time needed for the processor or processing system to enter a sleep state.

In block 806, the processing system may switch the processor and coprocessor to the sleep state within the predetermined duration or time period in response to each of the plurality of subsystems being switched to the sleep state. The processing system may transmit, from the coprocessor to the processor, a sleep state termination command upon determining that the sleep state acknowledgment has not been received by the coprocessor within the predetermined time period, such as upon expiration of the first timer. The coprocessor may trigger the plurality of subsystems and the processor to wake up in response to the first timer expiring.

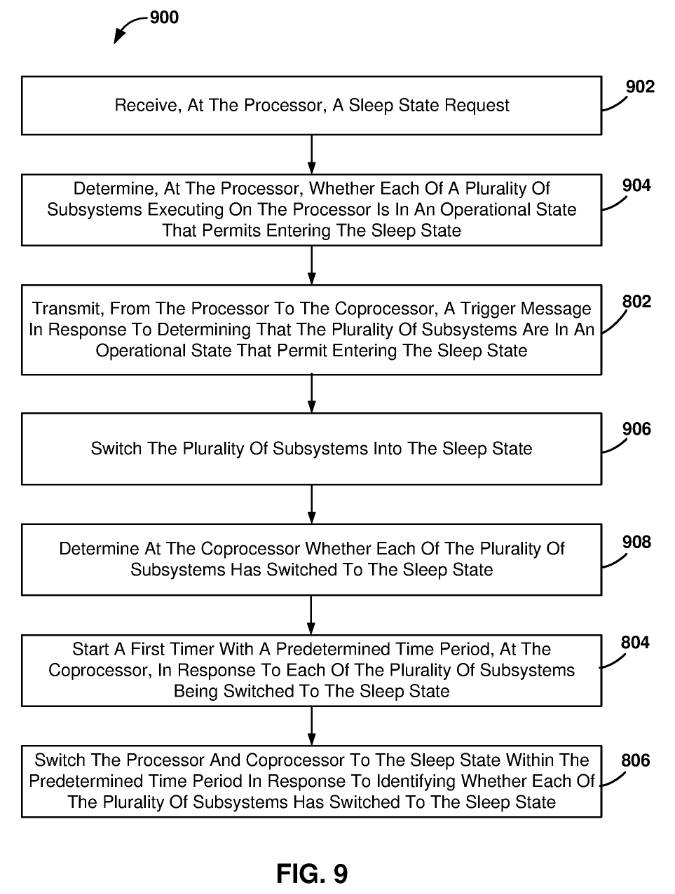

FIG. 9 is a process diagram illustrating an example method 900 suitable for implementing various embodiments. The operations of the method 900 may be performed by the computing device 320, SoC 106, SoC 302, or one or more components thereof (e.g., machine-readable instructions 426, processor(s) 422). In some embodiments, the vehicle may include a processor (e.g., processor 106, 422) configured to perform the operations by processor-executable instructions stored in a non-transitory processor-readable medium (e.g., memory 420, 112). Means for performing the operations of the method 900 may be a processing system (e.g., 100, 200, 300, 400) including one or more processors (e.g., 422), a wireless transceiver (e.g., 366, 352), and other components described herein. To encompass any of the processor(s), coprocessors, hardware elements, and software elements that may be involved in performing the method 900, the elements performing method operations are referred to as a “processing system”.

In block 902, the processing system may receive, by the processor, a sleep state request. Receiving a sleep state request by the processor may include receiving, by the processor, the sleep state request from a microcontroller of a vehicle based on a vehicle state change. The sleep state request may be based on an ignition switch or other switch being turned off.

In block 904, the processing system may determine, by the processor, whether each of a plurality of subsystems executing on the processor is in an operational state that permits entering the sleep state. As noted above, each subsystem may include computer-executable instructions that, when executed on the processor, cause the processor to evaluate the operational state of the subsystem, including such as I/O traffic, memory usage, and functionality in use.

In block 802, the processing system may transmit, from the processor to the coprocessor, a trigger message which may be in response to determining that the plurality of subsystems are in an operational state that permit entering the sleep state. The processing system may only transmit, from the processor to the coprocessor, a trigger message in response to determining that all the plurality of subsystems are in an operational state that permit entering the sleep state.

In block 906, the processing system may switch the plurality of subsystems into the sleep state. Switching to a sleep state may include receiving, by the plurality of subsystems, a sleep state command from the processor, switching the plurality of subsystems to a low power mode in response to the sleep state command, and switching off interrupts by the plurality of subsystems in response to the sleep state command, where the interrupts are configured to wake up the subsystem. Switching to a sleep state may include transmitting to the processor an acknowledgment confirming entry by each of the plurality of subsystems that entered into the sleep state. Each of the plurality of subsystems may transmit to the processor a request for a reduced shared resource allocation in response to receiving the sleep command.

In block 908, the processing system may determine by the coprocessor whether each of the plurality of subsystems has switched to the sleep state. The processing system may determine, by the processor, whether an acknowledgment confirming entry into the sleep state has been received from each of the plurality of subsystems (e.g., resource votes have been removed). The processing system may transmit a sleep state acknowledgment to the co-processor from the processor in response to determining that acknowledgments have been received from each of the plurality of subsystems.

In block 804, the processing system, particularly the coprocessor, may start a first timer with a predetermined time period which may be in response to identifying whether each of the plurality of subsystems has switched to the sleep state. The first timer (e.g., limbo mode timer) may be configured with a predetermined time period matching the time needed for the processor to enter a sleep state.

In block 806, the processing system may switch the processor and coprocessor to the sleep state within the predetermined time period, which may be in response to identifying that each of the plurality of subsystems has switched to the sleep state. The processing system may transmit, from the coprocessor to the processor, a sleep state termination command upon determining that the sleep state acknowledgment has not been received by the coprocessor within the predetermined time period, such as upon expiration of the first timer. The coprocessor may trigger the plurality of subsystems and the processor to wake up in response to the first timer expiring.

Various embodiments and implementations illustrated and described herein are provided merely as examples to illustrate various features of the claims. However, features shown and described with respect to any given embodiment or implementation are not necessarily limited to the associated embodiment or implementation and may be used or combined with other embodiments that are shown and described. Further, the claims are not intended to be limited by any one example embodiment or implementation. For example, one or more of the methods and operations of FIG. 9 may be substituted for or combined with one or more operations of the methods and operations of FIGS. 5-6 and 8.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include random access memory (RAM), read-only memory (ROM), electrically erasable programmable read-only memory (EEPROM), FLASH memory, solid-state drives (SSD), NVMe drives, three-dimensional (3D) NAND flash, or any other medium that may be used to store target program code in the form of instructions or data structures and that may be accessed by a computer.

Modern technologies, such as cloud-based storage solutions, including infrastructure-as-a-service (IaaS) platforms, may offer scalable and distributed options for storing and accessing program code. Additionally, the operations of a method or algorithm may reside as one or any combination or set of codes and/or instructions on a non-transitory processor-readable medium and/or computer-readable medium, which may be incorporated into a computer program product. Emerging technologies, including quantum computing storage media and blockchain-based storage solutions, may further enhance data integrity and security. Artificial intelligence (AI) and machine learning (ML)-optimized hardware accelerators, such as graphical processing units (GPUs) and tensor processing units (TPUs), may be used to execute complex algorithms.

Implementation examples are described in the following paragraphs. While some of the following implementation examples are described in terms of example methods, further example implementations may include the example methods discussed in the following paragraphs implemented by a user equipment (UE) including a processor configured with processor-executable instructions to perform operations of the methods of the following implementation examples; the example methods discussed in the following paragraphs implemented by a UE including means for performing functions of the methods of the following implementation examples; and the example methods discussed in the following paragraphs may be implemented as a non-transitory processor-readable storage medium having stored thereon processor-executable instructions configured to cause a processor of a UE to perform the operations of the methods of the following implementation examples.

Example 1. A method for coordinating a sleep state for a processor and a coprocessor within a processing system, including: transmitting, from the processor to the coprocessor, a trigger message that the plurality of subsystems are in operational states that permit entering the sleep state; starting, by the coprocessor a first timer with a predetermined time period, in response to each of the plurality of subsystems being switched to the sleep state; and switching the processor and the coprocessor to the sleep state within the predetermined time period in response to each of the plurality of subsystems being switched to the sleep state.

Example 2. The method of example 1, further including receiving, by the processor, the sleep state request which includes receiving, by the processor, the sleep state request from a microcontroller of a vehicle based on a vehicle state change.

Example 3. The method of either of examples 1 or 2, further including switching the plurality of subsystems into the sleep state which includes receiving, by the plurality of subsystems, a sleep state command from the processor; switching the plurality of subsystems to a low-power mode in response to the sleep state command; switching off interrupts by the plurality of subsystems in response to the sleep state command; and transmitting to the processor an acknowledgment confirming entry by each of the plurality of subsystems that entered into the sleep state.

Example 4. The method of example 3, in which each of the plurality of subsystems transmits, to the processor, a request to a reduced shared resource allocation in response to receiving the sleep state command.

Example 5. The method of example 3, including: determining, by the processor, whether an acknowledgment confirming entry into the sleep state has been received from each of the plurality of subsystems; and transmitting a sleep state acknowledgment to the coprocessor from the processor in response to determining that acknowledgments have been received from each of the plurality of subsystems.

Example 6. The method of example 5, including transmitting, from the coprocessor to the processor, a sleep state termination command upon determining that the sleep state acknowledgment has not been received by the coprocessor within the predetermined time period.

Example 7. The method of any of examples 1-6, in which a coprocessor clock of the coprocessor is independent from a clock of the processor, and in which a coprocessor power supply (the power supply for the coprocessor) is independent from a power supply of the processor

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process-related communication methodologies.

A number of different cellular and mobile communication services and standards are available or contemplated in the future, all of which may implement and benefit from the various embodiments. Such services and standards include, e.g., third-generation partnership project (3GPP), long-term evolution (LTE) systems, third-generation wireless mobile communication technology (3G), fourth-generation wireless mobile communication technology (4G), fifth-generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020TM), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, include compact disc (CD), laser disc, optical disc, digital versatile disc (DVD), floppy disc, and Blu-ray disc, where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments described herein but is to be accorded the widest scope consistent with the following claims and the principles and novel features disclosed herein.

What is claimed is:

1. A method for coordinating a sleep state for a processor and a coprocessor within a processing system, comprising:
transmitting, from the processor to the coprocessor, a trigger message that a plurality of subsystems are in operational states that permit entering the sleep state;
starting, by the coprocessor, a first timer with a predetermined time period in response to determining that each of the plurality of subsystems has switched to the sleep state; and
switching the processor and the coprocessor to the sleep state within the predetermined time period in response to each of the plurality of subsystems being switched to the sleep state.

2. The method of claim 1, further comprising: receiving, by the processor, a sleep state request including receiving, by the processor, the sleep state request from a microcontroller of a vehicle based on a vehicle state change.

3. The method of claim 1, further comprising: switching the plurality of subsystems into the sleep state by:
receiving, by the plurality of subsystems, a sleep state command from the processor;
switching the plurality of subsystems to a low-power mode in response to the sleep state command;
switching off interrupts by the plurality of subsystems in response to the sleep state command; and
transmitting to the processor an acknowledgment confirming entry by each of the plurality of subsystems that entered into the sleep state.

4. The method of claim 3, wherein each of the plurality of subsystems transmits, to the processor, a request to a reduced shared resource allocation in response to receiving the sleep state command.

5. The method of claim 3, further comprising;
determining, by the processor, whether an acknowledgment confirming entry into the sleep state has been received from each of the plurality of subsystems; and
transmitting a sleep state acknowledgment to the coprocessor from the processor in response to determining that acknowledgments have been received from each of the plurality of subsystems.

6. The method of claim 5, further comprising:
transmitting, from the coprocessor to the processor, a sleep state termination command upon determining that the sleep state acknowledgment has not been received by the coprocessor within the predetermined time period.

7. The method of claim 1, wherein a coprocessor clock of the coprocessor is independent from a clock of the processor, and wherein a coprocessor power supply is independent from a power supply of the processor.

8. A computing system, comprising:
at least one memory;
a coprocessor coupled to the at least one memory; and
a processor coupled to the coprocessor and the at least one memory, wherein the processor is configured to:
transmit to the coprocessor a trigger message that the plurality of subsystems are in operational states that permit entering a sleep state; and
wherein the coprocessor is configured to:
start a first timer with a predetermined time period in response to each of the plurality of subsystems being switched to the sleep state; and
switch to the sleep state within the predetermined time period in response to each of the plurality of subsystems being switched to the sleep state.

9. The computing system of claim 8, wherein the processor further configured to receive a sleep state request from a microcontroller of a vehicle based on a vehicle state change.

10. The computing system of claim 8, wherein the plurality of subsystems are configured to:
receive a sleep state command from the processor;
switch to a low-power mode in response to the sleep state command;
switch off interrupts in response to the sleep state command; and
transmit an acknowledgment confirming entry by each of the plurality of subsystems into the sleep state.

11. The computing system of claim 10, wherein each of the plurality of subsystems transmits, to the processor, a request to reduce a shared resource allocation in response to receiving the sleep state command.

12. The computing system of claim 10, wherein the processor is further configured to:
determine whether an acknowledgment confirming entry into the sleep state has been received from each of the plurality of subsystems; and
transmit a sleep state acknowledgment to the coprocessor from the processor in response to determining that acknowledgments have been received from each of the plurality of subsystems.

13. The computing system of claim 12, wherein the coprocessor is further configured to:
transmit, to the processor, a sleep state termination command upon determining that the sleep state acknowledgment has not been received by the coprocessor within the predetermined time period.

14. The computing system of claim 8, wherein a coprocessor clock of the coprocessor is independent from a clock of the processor, and wherein a coprocessor power supply is independent from a power supply of the processor.

15. A non-transitory processor-readable medium having stored thereon processor-executable instructions configured to cause a processor and a coprocessor of a computing device to perform operations comprising:
transmitting, from the processor to the coprocessor, a trigger message that the plurality of subsystems are in operational states that permit entering a sleep state;
starting, by the coprocessor a first timer with a predetermined time period, in response to each of the plurality of subsystems being switched to the sleep state; and
switching the processor and the coprocessor to the sleep state within the predetermined time period in response to each of the plurality of subsystems being switched to the sleep state.

16. The non-transitory processor-readable medium of claim 15, wherein the stored processor-executable instructions are further configured to cause the processor to receive a sleep state request from a microcontroller of a vehicle based on a vehicle state change.

17. The non-transitory processor-readable medium of claim 15, wherein stored the processor-executable instructions are further configured to cause the plurality of subsystems of the computing device to perform operations comprising:
receiving a sleep state command from the processor;
switching the plurality of subsystems to a low-power mode in response to the sleep state command;
switching off interrupts by the plurality of subsystems in response to the sleep state command; and
transmitting to the processor an acknowledgment confirming entry by each of the plurality of subsystems that entered into the sleep state.

18. The non-transitory processor-readable medium of claim 17, wherein the stored processor-executable instructions are further configured to cause each of the plurality of subsystems to transmit, to the processor, a request to a reduced shared resource allocation in response to receiving the sleep state command.

19. The non-transitory processor-readable medium of claim 17, wherein the stored processor-executable instructions are further configured to cause the processor and the coprocessor of the computing device to perform operations comprising:
determining, by the processor, whether an acknowledgment confirming entry into the sleep state has been received from each of the plurality of subsystems; and
transmitting a sleep state acknowledgment to the coprocessor from the processor in response to determining that acknowledgments have been received from each of the plurality of subsystems.

20. The non-transitory processor-readable medium of claim 19, wherein the stored processor-executable instructions are further configured to cause the coprocessor of the computing device to perform operations comprising:
transmitting a sleep state termination command to the processor upon determining that the sleep state acknowledgment has not been received by the coprocessor within the predetermined time period.
